(19) United States
(12) Patent Application Publication
(10) Pub. No.: US 2026/0160103 A1
(43) Pub. Date: Jun. 11, 2026

(54) MONOTRACK EMBEDDED HINGE AUTOMATIC DOOR-CLOSING MECHANISM

(71) Applicant: JIANGSU SARCAH GROUP CO., LTD., Taizhou (CN)

(72) Inventors: Tao HU, Shenzhen (CN); Xiang ZHANG, Fuyang (CN); Deya XU, Taizhou (CN); Shuangli ZHANG, Taizhou (CN); Wenming YANG, Singapore (SG)

(21) Appl. No.: 18/707,614

(22) PCT Filed: Dec. 1, 2021
(86) PCT No.: PCT/CN2021/134741

§ 371 Date: May 6, 2024

(30) Foreign Application Priority Data
Nov. 8, 2021 (CN) 202111316133.6

(51) Int. Cl. E05F 1/12

(52) U.S. Cl. CPC E05F 1/1269

(57) ABSTRACT

A door closing mechanism, including a single guide track mechanism provided on a door mounting block, a connecting rod mechanism and a cabinet mounting plate, wherein a spring mounting rod is fixed on the door mounting block, an angle retaining block is rotatably fixed on a panel of the door mounting block, an outer wall of the angle retaining block is slidably connected with a top end of a chute rod, and when the chute rod is moved in a guide chute, the top end of the chute rod drives the angle retaining block to rotate, and a reset spring is mounted between the angle retaining block and the spring mounting rod; in the automatic door-closing mechanism, by a coordinating action of the angle retaining block and the chute rod for guiding track changing, angle retaining and automatic door closing actions.

### CROSS-REFERENCE TO RELATED APPLICATIONS

The application claims priority of Chinese Patent Application No. CN2021113161336, filed on Nov. 8, 2021, the contents of which are incorporated herein by reference.

### TECHNICAL FIELD

The present invention relates to a hinge mechanism, and in particular, to a monotrack embedded hinge automatic door-closing mechanism.

### BACKGROUND

An embedded hinge is mainly used for an embedded refrigerator or an embedded cupboard, the embedded refrigerator is generally wholly embedded into a customized cupboard, and in order to realize precise embedding, a gap between an outer wall of the refrigerator and an inner wall of the customized cupboard is generally set to be quite small, such that when a refrigerator door is opened, a vertical hinged edge of the rotating refrigerator door is quite prone to hit the inner wall of the outside customized cupboard, and therefore, on the premise of guaranteeing an embedding fit degree between the refrigerator and the customized cupboard, smooth opening of the refrigerator door becomes a problem.

For the problem that the opened refrigerator door is prone to be forgotten to be closed, a spring mechanism is generally added between the refrigerator door and a cabinet, and the opened refrigerator door is closed by spring tension; however, deformation of a spring for resetting is generally large in the process of opening the refrigerator door, the spring has large mechanical abrasion, and the repeated large displacement deformation causes a service life of the spring to be short, which leads to the following two problems: first, when the refrigerator door is new, an automatic closing action of the refrigerator door is large, and the closing action of the refrigerator door is noisy; second, after used for a period of time, the refrigerator door cannot be closed and tightly attached to the cabinet by the automatic door closing action due to loss of elasticity of the spring.

Therefore, in view of the above problems, there is a need for an embedded-hinge automatic closing mechanism which can prolong the service life of the spring and can be suitable for the embedded door and cabinet.

### SUMMARY

An object of the present invention is to provide a monotrack embedded hinge automatic door-closing mechanism to solve the problems in the Background.

In order to achieve the object, the present invention provides the following technical solution:
a monotrack embedded hinge automatic door-closing mechanism includes a door mounting block configured to be mounted on a rotating door and a cabinet mounting plate configured to be mounted on a cabinet matched with the door, wherein the cabinet mounting plate drives the door mounting block to rotate through a horizontally rotating connecting rod mechanism, a single guide track mechanism configured to guide the door mounting block to contract and change a track is provided between the door mounting block and the cabinet mounting plate, the single guide track mechanism includes a chute rod vertically fixed on the cabinet mounting plate and a guide chute formed in the door mounting block, and the chute rod vertically upwards penetrates through the guide chute and guides a rotating action of the door mounting block along an interior of the guide chute;
a spring mounting rod is fixed on the door mounting block, an angle retaining block is rotatably fixed on a panel of the door mounting block on a side opposite to the spring mounting rod, an outer wall of the angle retaining block is slidably connected with a top end of the chute rod, and when the chute rod is moved in the guide chute, the top end of the chute rod drives the angle retaining block to rotate; a reset spring is mounted between the angle retaining block and the spring mounting rod, and when the door mounting block is rotated to a side of attachment to the cabinet mounting plate and is in a closed state, the reset spring is in a stretched state, the angle retaining block tightly abuts against the chute rod without displacement, and when the door mounting block is moved to a fully opened position, the angle retaining block is overturned to the top end of the chute rod and kept at the top end, and in the overturning process of the angle retaining block, the reset spring provides a closing rotating force for the door mounting block, and when the top end of the chute rod is fixed at a bottom of the angle retaining block, the reset spring does not provide the closing rotating force for the door mounting block.

In a further solution: the angle retaining block includes a hook configured to hang one end of the reset spring and a contact arc surface formed on a side wall, a block shaft hole is formed in a middle of the angle retaining block, a block rotating shaft slidably penetrates through the block shaft hole, two outer ends of the block rotating shaft are rotatably fixed on a block rotating groove frame, the block rotating groove frame is vertically provided on two sides of a top opening of the guide chute, and when the door mounting block and the cabinet mounting plate are in a closed state, the contact arc surface tightly abuts against a position of a rod wall of the chute rod, an opening position of the hook is opposite to a direction of tension provided by the reset spring for the angle retaining block, the angle retaining block is integrally tightly attached to the rod wall of the chute rod by the tension of the reset spring to be kept in a static state, and in the process of completely opening the door mounting block and the cabinet mounting plate, the angle retaining block is overturned upwards, and the top end of the chute rod abuts against the contact arc surface.

In a still further solution: the guide chute is transversely formed in the door mounting block, and when the door mounting block and the cabinet mounting plate are closed, the chute rod is located on a rightmost side of the guide chute, and in the process of opening the door mounting block and the cabinet mounting plate, with the door mounting block as a fixed reference system, the chute rod slides towards a leftmost side relative to the guide chute.

In a still further solution: an annular anti-falling protrusion protruding out of a surface of the door mounting block is fixed on the opening of the guide chute in an extension mode.

In a still further solution: the connecting rod mechanism includes a limiting fixed shaft, a limiting connecting rod and a limiting swing shaft, the limiting fixed shaft is rotatably fixed on a panel of the cabinet mounting plate, the limiting connecting rod is horizontally fixed on a top rod wall of the limiting fixed shaft, the limiting swing shaft is vertically fixed at a top of an outer end of the limiting connecting rod, and a top end of the limiting swing shaft is rotatably fixed in a middle of the door mounting block.

In a still further solution: the limiting connecting rod is a flat plate, a gap between the door mounting block and the cabinet mounting plate is smaller than 10 mm, and a space size required to be occupied in a vertical direction by mounting is mainly reduced to ensure that the whole mechanism is more precise and easy to mount.

Compared with the prior art, the present invention has the following beneficial effects.
1. In the present invention, by a coordinating action of the angle retaining block and the chute rod for guiding track changing, angle retaining and automatic door closing actions can be realized under the condition of reducing other members, a track change action is well combined with an integral elastic reset state, stress of the reset spring is uniform in an automatic door closing process, and the door closing action is smoother, which is different from the condition that a traditional spring directly acts between the door and the cabinet and the stress of the spring is not uniform.
2. In the process of large angle opening and closing of the door and the cabinet, the reset spring is only subjected to small displacement stretching at the angle retaining block and the chute rod, thus greatly reducing deformation stretching of the spring, reducing mechanical abrasion of the spring, and prolonging a service life of the spring.

### BRIEF DESCRIPTION OF THE DRAWINGS

FIG. 1 is a schematic structural diagram of a closed state of a monotrack embedded hinge automatic door-closing mechanism.

FIG. 2 is a schematic structural diagram of an opened state of the monotrack embedded hinge automatic door-closing mechanism.

FIG. 3 is an exploded view of the state of FIG. 1.

FIG. 4 is an exploded view of the state of FIG. 2.

FIG. 5 is a schematic structural diagram of an angle retaining block in the monotrack embedded hinge automatic door-closing mechanism.

FIG. 6 is a schematic structural diagram of an anti-falling protrusion in the monotrack embedded hinge automatic door-closing mechanism.

In the drawings: door mounting block 1, spring mounting rod 10, block rotating groove frame 11, anti-falling protrusion 12, reset spring 13, guide chute 14, swing shaft hole 15, cabinet mounting plate 2, chute rod 20, limiting fixed shaft 21, limiting connecting rod 22, limiting swing shaft 23, angle retaining block 3, block shaft hole 30, contact arc surface 31, hook 32, and block rotating shaft 33.

### DETAILED DESCRIPTION

The technical solutions in the embodiments of the present invention are clearly and completely described with reference to the accompanying drawings in the embodiments of the present invention, and apparently, the described embodiments are not all but only a part of the embodiments of the present invention. All other embodiments obtained by a person of ordinary skill in the art based on the embodiments of the present invention without creative efforts shall fall within the protection scope of the present invention.

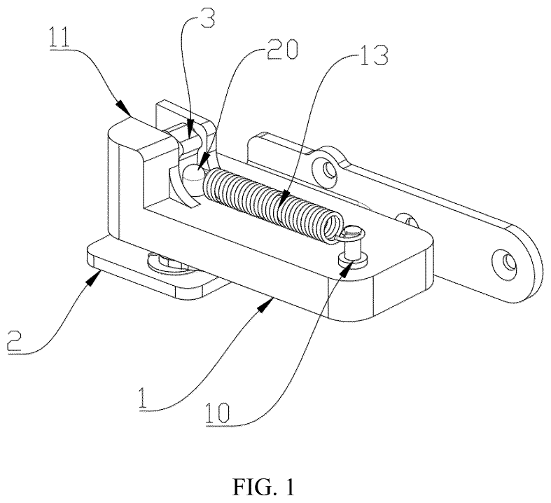

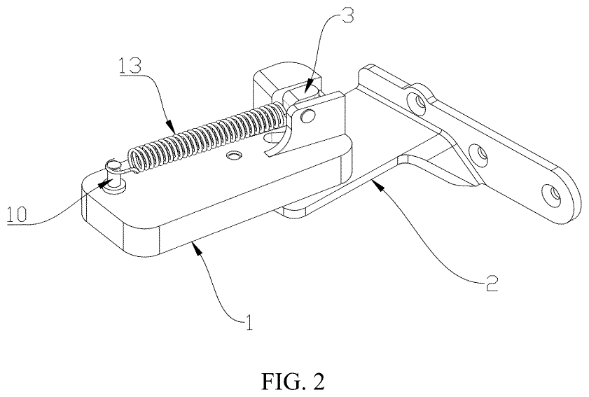

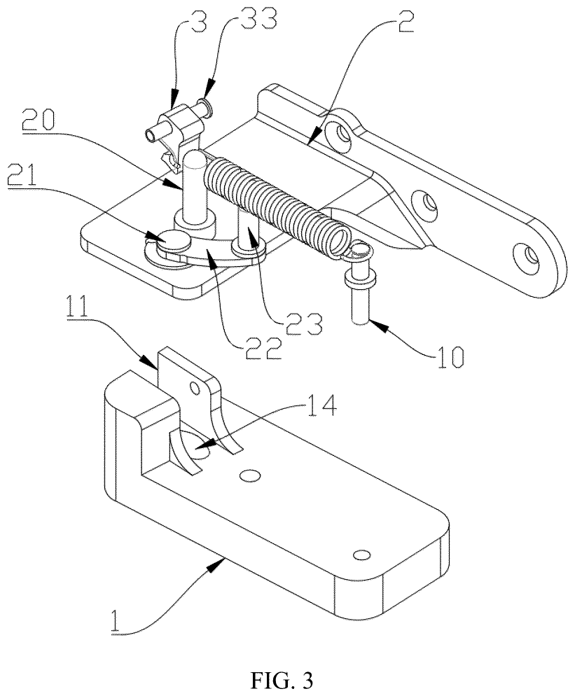

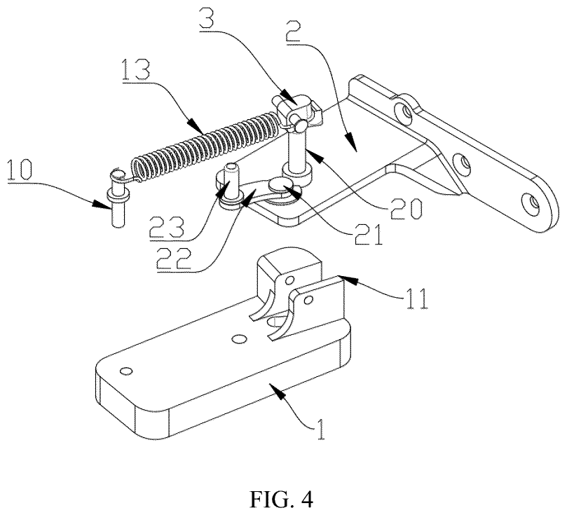

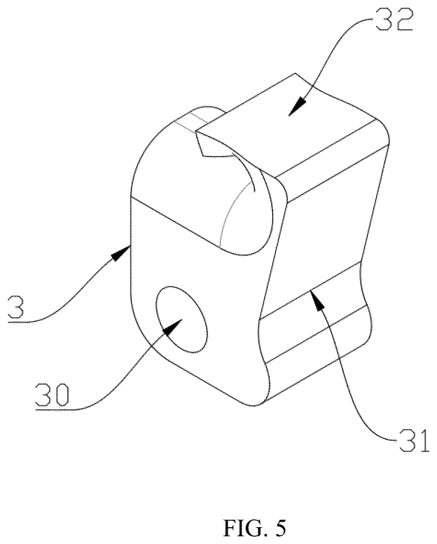

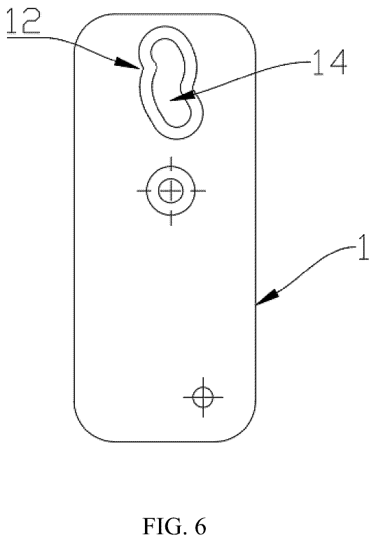

Referring to FIGS. 1 to 6, in the embodiment of the present invention, a monotrack embedded hinge automatic door-closing mechanism includes a door mounting block 1 configured to be mounted on a rotating door and a cabinet mounting plate 2 configured to be mounted on a cabinet matched with the door, wherein the cabinet mounting plate 2 drives the door mounting block 1 to rotate through a horizontally rotating connecting rod mechanism, a single guide track mechanism configured to guide the door mounting block 1 to contract and change a track is provided between the door mounting block 1 and the cabinet mounting plate 2, the single guide track mechanism includes a chute rod 20 vertically fixed on the cabinet mounting plate 2 and a guide chute 14 formed in the door mounting block 1, and the chute rod 20 vertically upwards penetrates through the guide chute 14 and guides a rotating action of the door mounting block 1 along an interior of the guide chute 14; a spring mounting rod 10 is fixed on the door mounting block 1, an angle retaining block 3 is rotatably fixed on a panel of the door mounting block 1 on a side opposite to the spring mounting rod 10, an outer wall of the angle retaining block 3 is slidably connected with a top end of the chute rod 20, and when the chute rod 20 is moved in the guide chute 14, the top end of the chute rod 20 drives the angle retaining block 3 to rotate; a reset spring 13 is mounted between the angle retaining block 3 and the spring mounting rod 10, and when the door mounting block 1 is rotated to a side of attachment to the cabinet mounting plate 2 and is in a closed state, the reset spring 13 is in a stretched state, the angle retaining block 3 tightly abuts against the chute rod 20 without displacement, and when the door mounting block 1 is moved to a fully opened position, the angle retaining block 3 is overturned to the top end of the chute rod 20 and kept at the top end, and in the overturning process of the angle retaining block 3, the reset spring 13 provides a closing rotating force for the door mounting block 1, and when the top end of the chute rod 20 is fixed at a bottom of the angle retaining block 3, the reset spring 13 does not provide the closing rotating force for the door mounting block 1.

The angle retaining block 3 includes a hook 32 configured to hang one end of the reset spring 13 and a contact arc surface 31 formed on a side wall, a block shaft hole 30 is formed in a middle of the angle retaining block 3, a block rotating shaft 33 slidably penetrates through the block shaft hole 30, two outer ends of the block rotating shaft 33 are rotatably fixed on a block rotating groove frame 11, the block rotating groove frame 11 is vertically provided on two sides of a top opening of the guide chute 14, and when the door mounting block 1 and the cabinet mounting plate 2 are in a closed state, the contact arc surface 31 tightly abuts against a position of a rod wall of the chute rod 20, an opening position of the hook 32 is opposite to a direction of tension provided by the reset spring 13 for the angle retaining block 3, the angle retaining block 3 is integrally tightly attached to the rod wall of the chute rod 20 by the tension of the reset spring 13 to be kept in a static state, and in the process of completely opening the door mounting block 1 and the cabinet mounting plate 2, the angle retaining block 3 is overturned upwards, and the top end of the chute rod 20 abuts against the contact arc surface 31; the provided angle retaining block 3 is slidably connected with a top end of the cabinet mounting plate 2 through the contact arc surface 31, and when the door mounting block 1 and the cabinet mounting plate 2 are in a closed state, the angle retaining block 3 is clamped on one side of the rod wall of the chute rod 20 under an action of the tension of the reset spring 13, the angle retaining block 3 does not rotate, the chute rod 20 is kept at a position in the guide chute 14, the door mounting block 1 and the cabinet mounting plate 2 have a closing retaining action, and in the process of opening the door mounting block 1, the chute rod 20 moving relatively pushes the angle retaining block 3 to rotate in the moving process, and in this process, the reset spring 13 always provides the elastic tension for the angle retaining block 3, and in this state, the angle retaining block 3 can automatically reset and rotate under an action of the reset spring 13, and therefore, the door mounting block 1 can be automatically closed; after the angle retaining block 3 is overturned to a top of the chute rod 20, the reset spring 13 does not provide a tangential component force for the angle retaining block 3, the door mounting block 1 cannot rotate under the action of the reset spring 13, and an angle of the door mounting block 1 is retained at this point, such that the door mounting block 1 can be automatically closed only in a small opening angle range, and after the door mounting block 1 is opened by a certain angle, the door mounting block 1 can keep the opening angle without an action of an external force, and small-angle automatic closing and large-angle retaining functions are achieved.

The guide chute 14 is transversely formed in the door mounting block 1, and when the door mounting block 1 and the cabinet mounting plate 2 are closed, the chute rod 20 is located on a rightmost side of the guide chute 14, and in the process of opening the door mounting block 1 and the cabinet mounting plate 2, with the door mounting block 1 as a fixed reference system, the chute rod 20 slides towards a leftmost side relative to the guide chute 14, such that the door mounting block 1 is integrally moved forwards in the rotating process, and a left end of the door mounting block 1 cannot impact a surface of the cabinet when rotating to be close to the cabinet side.

An annular anti-falling protrusion 12 protruding out of a surface of the door mounting block 1 is fixed on the opening of the guide chute 14 in an extension mode, and the provided anti-falling protrusion 12 is mainly configured to improve a lateral supporting force of the chute rod 20 and guarantee horizontal stability of the door mounting block 1 in the rotating process.

The connecting rod mechanism includes a limiting fixed shaft 21, a limiting connecting rod 22 and a limiting swing shaft 23, the limiting fixed shaft 21 is rotatably fixed on a panel of the cabinet mounting plate 2, the limiting connecting rod 22 is horizontally fixed on a top rod wall of the limiting fixed shaft 21, the limiting swing shaft 23 is vertically fixed at a top of an outer end of the limiting connecting rod 22, and a top end of the limiting swing shaft 23 is rotatably fixed in a middle of the door mounting block 1; in the opening process, the provided door mounting block 1 drives the limiting swing shaft 23 to rotate around the limiting fixed shaft 21, and an end of the door mounting block 1 at the guide chute 14 is guided by the chute rod 20 to generate a track changing swing; that is, as shown in FIG. 1, the door mounting block 1 is rotated clockwise to be opened in the opening process, and the left end of the door mounting block 1 is guided by the guide chute 14 and the chute rod 20 in the rotating process to generate an action of moving forwards towards a front side of the cabinet mounting plate 2, such that in the case of a quite small fit gap between the door mounting block 1 and the cabinet mounting plate 2, a left side end of the door mounting block 1 cannot hit the cabinet on a rear side of the door mounting block 1 in the rotating process, the door is guaranteed to be tightly attached to the cabinet, and the whole structure is conveniently embedded and mounted in an external cupboard.

The limiting connecting rod 22 is a flat plate, the gap between the door mounting block 1 and the cabinet mounting plate 2 is smaller than 10 mm, and a space size required to be occupied by mounting the door mounting block 1 and the cabinet mounting plate 2 in a vertical direction is mainly reduced to ensure that the whole mechanism is more precise and easy to mount.

The present invention has the working principle that during working, the door mounting block 1 is embedded on a left side of the door, the door matched with the door mounting block 1 is set to be opened clockwise, a rear end of the cabinet mounting plate 2 is fixed on the cabinet, the door mounting block 1 and the cabinet mounting plate 2 are kept horizontally parallel, and when the door is closed on the cabinet and in the closed state, the angle retaining block 3 abuts against a side wall of the chute rod 20 under the tension of the reset spring 13, the angle retaining block 3 cannot rotate, the door is tightly closed, and in the process of opening the door, the door mounting block 1 is opened clockwise, the angle retaining block 3 is overturned upwards with the block rotating shaft 33 as a rotating shaft, the contact arc surface 31 clockwise bypasses the end of the chute rod 20, the hook 32 end of the angle retaining block 3 stretches the reset spring 13, the reset spring 13 stores elastic potential energy for pulling the angle retaining block 3 to rotate anticlockwise, and when the contact arc surface 31 bypasses the top of the chute rod 20, the chute rod 20 only provides an upward pushing force for the contact arc surface 31, the reset spring 13 does not provide a reset rotary pushing force for the door mounting block 1 in a horizontal direction, and only when the door mounting block 1 is turned to rotate the angle retaining block 3 around the chute rod 20 again, the reset spring 13 pulls the angle retaining block 3 to rotate anticlockwise, the contact arc surface 31 bypasses the end of the chute rod 20 to move towards the rod wall of the chute rod 20, and the door mounting block 1 is automatically closed, such that the door mounting block 1 can be automatically closed within the small opening angle range, and after the door mounting block is opened to a certain angle, the angle can be kept, and therefore, in the present invention, by a coordinating action of the angle retaining block 3 and the chute rod 20 for guiding track changing, an automatic door closing action can be realized under the condition of reducing other members, a track change action is well combined with an integral elastic reset state, stress of the reset spring 13 is uniform in the automatic door closing process, and the door closing action is smoother, which is different from the condition that a traditional spring directly acts between the door and the cabinet, the stress of the spring is not uniform, and the door directly hits the cabinet, and the whole process is more silent; meanwhile, in the process of large angle opening and closing of the door and the cabinet, the reset spring 13 is only subjected to small displacement stretching at the angle retaining block 3 and the chute rod 20, thus greatly reducing deformation stretching of the spring, reducing mechanical abrasion of the spring, and prolonging a service life of the spring.

It will be evident to those skilled in the art that the present invention is not limited to the details of the foregoing illustrative embodiments, and the present invention may be embodied in other specific forms without departing from the spirit or essential features thereof. Therefore, the embodiments are to be considered in all respects as illustrative and not restrictive, the scope of the present invention being defined by the appended claims rather than by the foregoing description, and all changes which come within the meaning and range of equivalency of the claims are therefore intended to be embraced therein. Any reference numeral in the claims should not be construed as limiting the concerned claims.

Furthermore, it should be understood that although the specification is described in terms of embodiments, not every embodiment only includes an independent technical solution, and such description of the specification is for clarity only; those skilled in the art should take the specification as a whole, and the technical solutions in various embodiments may also be appropriately combined to form other embodiments that may be understood by those skilled in the art.

What is claimed is:

1. A monotrack embedded hinge automatic door-closing mechanism, comprising a door mounting block (1) configured to be mounted on a rotating door and a cabinet mounting plate (2) configured to be mounted on a cabinet matched with the door,
wherein the cabinet mounting plate (2) drives the door mounting block (1) to rotate through a horizontally rotating connecting rod mechanism, a single guide track mechanism configured to guide the door mounting block (1) to contract and change a track is provided between the door mounting block (1) and the cabinet mounting plate (2), the single guide track mechanism comprises a chute rod (20) vertically fixed on the cabinet mounting plate (2) and a guide chute (14) formed in the door mounting block (1), and the chute rod (20) vertically upwards penetrates through the guide chute (14) and guides a rotating action of the door mounting block (1) along an interior of the guide chute (14);
a spring mounting rod (10) is fixed on the door mounting block (1), an angle retaining block (3) is rotatably fixed on a panel of the door mounting block (1) on a side opposite to the spring mounting rod (10), an outer wall of the angle retaining block (3) is slidably connected with a top end of the chute rod (20), and when the chute rod (20) is moved in the guide chute (14), the top end of the chute rod (20) drives the angle retaining block (3) to rotate; a reset spring (13) is mounted between the angle retaining block (3) and the spring mounting rod (10), and when the door mounting block (1) is rotated to a side of attachment to the cabinet mounting plate (2) and is in a closed state, the reset spring (13) is in a stretched state, the angle retaining block (3) tightly abuts against the chute rod (20) without displacement, and when the door mounting block (1) is moved to a fully opened position, the angle retaining block (3) is overturned to the top end of the chute rod (20) and kept at the top end, and in the overturning process of the angle retaining block (3), the reset spring (13) provides a closing rotating force for the door mounting block (1), and when the top end of the chute rod (20) is fixed at a bottom of the angle retaining block (3), the reset spring (13) does not provide the closing rotating force for the door mounting block (1).

2. The monotrack embedded hinge automatic door-closing mechanism according to claim 1, wherein the angle retaining block (3) comprises a hook (32) configured to hang one end of the reset spring (13) and a contact arc surface (31) formed on a side wall, a block shaft hole (30) is formed in a middle of the angle retaining block (3), a block rotating shaft (33) slidably penetrates through the block shaft hole (30), two outer ends of the block rotating shaft (33) are rotatably fixed on a block rotating groove frame (11), the block rotating groove frame (11) is vertically provided on two sides of a top opening of the guide chute (14), and when the door mounting block (1) and the cabinet mounting plate (2) are in a closed state, the contact arc surface (31) tightly abuts against a position of a rod wall of the chute rod (20), an opening position of the hook (32) is opposite to a direction of tension provided by the reset spring (13) for the angle retaining block (3), the angle retaining block (3) is integrally tightly attached to the rod wall of the chute rod (20) by the tension of the reset spring (13) to be kept in a static state, and in the process of completely opening the door mounting block (1) and the cabinet mounting plate (2), the angle retaining block (3) is overturned upwards, and the top end of the chute rod (20) abuts against the contact arc surface (31).

3. The monotrack embedded hinge automatic door-closing mechanism according to claim 2, wherein the guide chute (14) is transversely formed in the door mounting block (1), and when the door mounting block (1) and the cabinet mounting plate (2) are closed, the chute rod (20) is located on a rightmost side of the guide chute (14), and in the process of opening the door mounting block (1) and the cabinet mounting plate (2), with the door mounting block (1) as a fixed reference system, the chute rod (20) slides towards a leftmost side relative to the guide chute (14).

4. The monotrack embedded hinge automatic door-closing mechanism according to claim 1, wherein an annular anti-falling protrusion (12) protruding out of a surface of the door mounting block (1) is fixed on the opening of the guide chute (14) in an extension mode.

5. The monotrack embedded hinge automatic door-closing mechanism according to claim 1, wherein the connecting rod mechanism comprises a limiting fixed shaft (21), a limiting connecting rod (22) and a limiting swing shaft (23), the limiting fixed shaft (21) is rotatably fixed on a panel of the cabinet mounting plate (2), the limiting connecting rod (22) is horizontally fixed on a top rod wall of the limiting fixed shaft (21), the limiting swing shaft (23) is vertically fixed at a top of an outer end of the limiting connecting rod (22), and a top end of the limiting swing shaft (23) is rotatably fixed in a middle of the door mounting block (1).

6. The monotrack embedded hinge automatic door-closing mechanism according to claim 5, wherein the limiting connecting rod (22) is a flat plate, and a gap between the door mounting block (1) and the cabinet mounting plate (2) is smaller than 10mm.
